(19) United States
(12) Patent Application Publication
(10) Pub. No.: US 2018/0123752 A1
(43) Pub. Date: May 3, 2018

(54) METHOD AND APPARATUS FOR HANDLING DATA ACTIVITY OF A SECONDARY CELL

(71) Applicant: NOKIA SOLUTIONS AND NETWORKS OY, Espoo (FI)

(72) Inventors: Rossella DE BENEDITTIS, Ulm (DE); Mieszko CHMIEL, Wroclaw (PL); Daniel TAYLOE, Phoenix, AZ (US); Tero HENTTONEN, Espoo (FI)

(21) Appl. No.: 15/567,689

(22) PCT Filed: Apr. 20, 2015
(86) PCT No.: PCT/US15/26681

§ 371 Date: Oct. 19, 2017

(51) Int. Cl. H04L 5/00; H04W 24/08; H04W 72/08

(52) U.S. Cl. CPC H04L 5/0032; H04W 76/025; H04W 72/085; H04W 24/08; H04L 5/0057

(57) ABSTRACT

A method and apparatus may include determining a channel between a secondary cell and a user equipment. The method may also include transmitting information relating to the channel to a primay cell of a second network node. The transmitting the information comprises transmitting via an interface between the secondary cell and the primary cell.

### BACKGROUND

### Field

Embodiments of the present invention relate to handling data activity of a secondary cell.

### Description of the Related Art

Long-term Evolution (LTE) is a standard for wireless communication that seeks to provide improved speed and capacity for wireless communications by using new modulation/signal processing techniques. The standard was proposed by the 3^{rd} Generation Partnership Project (3GPP), and is based upon previous network technologies. Since its inception, LTE has seen extensive deployment in a wide variety of contexts involving the communication of data.

### SUMMARY:

According to a first embodiment, a method may include determining, by a first network node, a channel between a secondary cell and a user equipment. The method may also include transmitting information relating to the channel to a primary cell of a second network node. The transmitting the information comprises transmitting via an interface between the secondary cell and the primary cell, for example, via X2-U protocol or X2-C protocol between two LTE network nodes.

In the method of the first embodiment, the first network node comprises a secondary evolved Node B. The second network node comprises a master evolved Node B. The information exchanged between the secondary cell and the primary cell is exchanged via an external X2 interface between the secondary evolved Node B and the master evolved Node B.

In the method of the first embodiment, the first network node and the second network node correspond to the same evolved Node B. The information exchanged between the secondary cell and the primary cell is exchanged via an internal X2 interface within the evolved Node B.

In the method of the first embodiment, the first network node and the second network node belong to different radio technologies and the information exchanged between the secondary cell and the primary cell is exchanged via an external interface defined between the secondary network node and the primary network node.

In the method of the first embodiment, the first network node is a WLAN. The second network node is an evolved Node B. The information exchanged between the secondary cell and the primary cell is exchanged via an external Xw interface defined between the WLAN and the evolved Node B.

In the method of the first embodiment, the transmitting information relating to the channel comprises transmitting via the X2-U protocol. The transmitting information comprises transmitting at least one of information that a channel quality of the channel has become bad, information that a channel quality of the channel has become good, and information that the secondary cell is no longer detectable by the user equipment.

In the method of the first embodiment, the method may also include transmitting X2-U DL DELIVERY STATUS to the second network node. X2-U DL DELIVERY STATUS comprises a “Status of the Connection” information.

In the method of the first embodiment, the transmitting the information relating to the channel comprises transmitting via the X2-C protocol. The transmitting information comprises transmitting at least one of information relating to activation of a measurement configuration at the user equipment, information relating to deactivation of a measurement configuration at the user equipment, and information indicating that the secondary cell is no longer detectable by the user equipment.

In the method of the first embodiment, the transmitting information relating to the channel measurement comprises transmitting information so that the second network node triggers appropriate measurement activation at the user equipment.

According to a second embodiment, an apparatus may include at least one processor. The apparatus may also include at least one memory including computer program code. The at least one memory and the computer program code may be configured, with the at least one processor, to cause the apparatus at least to determine a channel between a secondary cell and a user equipment. The apparatus may also be caused to transmit information relating to the channel to a primary cell of a network node. The transmitting the information comprises transmitting via an interface between the secondary cell and the primary cell.

In the apparatus of the second embodiment, the apparatus comprises a secondary evolved Node B. The network node comprises a master evolved Node B. The information exchanged between the secondary cell and the primary cell is exchanged via an external X2 interface between the secondary evolved Node B and the master evolved Node B.

In the apparatus of the second embodiment, the apparatus and the network node correspond to the same evolved Node B. The information exchanged between the secondary cell and the primary cell is exchanged via an internal X2 interface within the evolved Node B.

In the apparatus of the second embodiment, the apparatus and the network node belong to different radio technologies and the information exchanged between the secondary cell and the primary cell is exchanged via an external interface defined between the secondary network node and the primary network node

In the apparatus of the second embodiment, the apparatus is a WLAN, the network node is an evolved Node B, and the information exchanged between the secondary cell and the primary cell is exchanged via an external Xw interface defined between the WLAN and the evolved Node B.

In the apparatus of the second embodiment, the transmitting information relating to the channel comprises transmitting via the X2-U protocol. The transmitting information comprises transmitting at least one of information that a channel quality of the channel has become bad, information that a channel quality of the channel has become good, and information that the secondary cell is no longer detectable by the user equipment.

In the apparatus of the second embodiment, the apparatus is further caused to transmit X2-U DL DELIVERY STATUS to the network node, wherein X2-U DL DELIVERY STATUS comprises a “Status of the Connection” information.

In the apparatus of the second embodiment, the transmitting the information relating to the channel comprises transmitting via the X2-C protocol. The transmitting information comprises transmitting at least one of information relating to activation of a measurement configuration at the user equipment, information relating to deactivation of a measurement configuration at the user equipment, and information indicating that the secondary cell is no longer detectable by the user equipment.

In the apparatus of the second embodiment, the transmitting information relating to the channel measurement comprises transmitting information so that the network node triggers appropriate measurement activation at the user equipment.

According to a third embodiment, a computer program product may be embodied on a non-transitory computer readable medium. The computer program product may be configured to control a processor to perform a method according to the first embodiment.

According to a fourth embodiment, a method may include determining, by a first network node, a channel between a secondary cell and a user equipment. The method may also include receiving information relating to the channel from a second network node.

In the method of the fourth embodiment, the second network node comprises a secondary evolved Node B, and the first network node comprises a master evolved Node B.

In the method of the fourth embodiment, the secondary evolved Node B and the master evolved Node B are the same evolved Node B.

In the method of the fourth embodiment, the second network node comprises a master evolved Node B and the first network node comprises a node of different radio technology.

In the method of the fourth embodiment, the second network node comprises a master evolved Node B and the first network node comprises a WLAN.

In the method of the fourth embodiment, the receiving information relating to the channel comprises receiving via the X2-U protocol. The receiving information comprises receiving at least one of information that a channel quality of the channel has become bad, information that a channel quality of the channel has become good, and information that the secondary cell is no longer detectable by the user equipment.

In the method of the fourth embodiment, the method may also include receiving X2-U DL DELIVERY STATUS from the second network node. X2-U DL DELIVERY STATUS comprises a “Status of the Connection” information.

In the method of the fourth embodiment, the receiving the information relating to the channel comprises receiving via the X2-C protocol. The receiving information comprises receiving at least one of information relating to activation of a measurement configuration at the user equipment, information relating to deactivation of a measurement configuration at the user equipment, and information indicating that the secondary cell is no longer detectable by the user equipment.

In the method of the fourth embodiment, the method may also include activating inter-frequency A3 or A5 measurements at the user equipment, if the channel quality of the channel is bad. The method may also include activating inter-frequency A4 measurements at the user equipment, if the secondary cell becomes undetectable. The method may also include deactivating measurements, if the channel quality is good.

According to a fifth embodiment, an apparatus may include at least one processor. The apparatus may also include at least one memory including computer program code. The at least one memory and the computer program code may be configured, with the at least one processor, to cause the apparatus at least to determine a channel between a secondary cell and a user equipment. The apparatus may also be caused to receive information relating to the channel from a network node.

In the apparatus of the fifth embodiment, the network node comprises a secondary evolved Node B, and the apparatus comprises a master evolved Node B.

In the apparatus of the fifth embodiment, the secondary evolved Node B and the master evolved Node B are the same evolved NodeB.

In the apparatus of the fifth embodiment, the second network node comprises a master evolved Node B and the apparatus comprises a node of different radio technology

In the apparatus of the fifth embodiment, the network node comprises a master evolved Node B and the apparatus comprises a WLAN.

In the apparatus of the fifth embodiment, the receiving information relating to the channel comprises receiving via the X2-U protocol, and the receiving information comprises receiving at least one of information that a channel quality of the channel has become bad, information that a channel quality of the channel has become good, and information that the secondary cell is no longer detectable by the user equipment.

In the apparatus of the fifth embodiment, the apparatus is further caused to receive X2-U DL DELIVERY STATUS from the network node. X2-U DL DELIVERY STATUS comprises a “Status of the Connection” information.

In the apparatus of the fifth embodiment, the receiving the information relating to the channel comprises receiving via the X2-C protocol, the receiving information comprises receiving at least one of information relating to activation of a measurement configuration at the user equipment, information relating to deactivation of a measurement configuration at the user equipment, and information indicating that the secondary cell is no longer detectable by the user equipment.

In the apparatus of the fifth embodiment, the apparatus is further caused to activate inter-frequency A3 or A5 measurements at the user equipment, if the channel quality of the channel is bad. The apparatus may also be caused to activate inter-frequency A4 measurements at the user equipment, if the secondary cell becomes undetectable. The apparatus may also be caused to deactivate measurements, if the channel quality is good.

According to a sixth embodiment, a computer program product may be embodied on a non-transitory computer readable medium. The computer program product may be configured to control a processor to perform a method according to the fourth embodiment.

According to a seventh embodiment, a method may include determining, by a network node, a channel between a secondary cell and a user equipment. The method may also include determining information relating to the channel. The information comprises at least one of information that a channel quality of the channel has become bad, information that a channel quality of the channel has become good, and information that the secondary cell is no longer detectable by the user equipment. The method may also include activating measurements based on the determined information.

According to an eighth embodiment, an apparatus may include at least one processor. The apparatus may also include at least one memory including computer program code. The at least one memory and the computer program code may be configured, with the at least one processor, to cause the apparatus at least to determine a channel between a secondary cell and a user equipment. The apparatus may also be caused to determine information relating to the channel. The information comprises at least one of information that a channel quality of the channel has become bad, information that a channel quality of the channel has become good, and information that the secondary cell is no longer detectable by the user equipment. The apparatus may also be caused to activate measurements based on the determined information.

According to a ninth embodiment, a computer program product may be embodied on a non-transitory computer readable medium. The computer program product may be configured to control a processor to perform a method according to the seventh embodiment.

According to a tenth embodiment, an apparatus may include determining means that determines a channel between a secondary cell and a user equipment. The apparatus may also include transmitting means that transmits information relating to the channel to a primary cell of a second network node. The transmitting the information comprises transmitting via an interface between the secondary cell and the primary cell.

According to an eleventh embodiment, an apparatus may include determining means that determines a channel between a secondary cell and a user equipment. The apparatus may also include receiving means that receives information relating to the channel from a network node.

According to a twelfth embodiment, an apparatus may include first determining means that determines a channel between a secondary cell and a user equipment. The apparatus may also include second determining means that determines information relating to the channel. The information comprises at least one of information that a channel quality of the channel has become bad, information that a channel quality of the channel has become good, and information that the secondary cell is no longer detectable by the user equipment. The apparatus may also include activating means that activates measurements based on the determined information.

### BRIEF DESCRIPTION OF THE DRAWINGS:

For proper understanding of the invention, reference should be made to the accompanying drawings, wherein:

FIG. 1 illustrates a “status of the connection” byte in accordance with certain embodiments of the invention.

FIG. 2 illustrates a flowchart of a method in accordance with certain embodiments of the invention.

FIG. 3 illustrates a flowchart of a method in accordance with certain embodiments of the invention.

FIG. 4 illustrates a flowchart of a method in accordance with certain embodiments of the invention.

FIG. 5 illustrates an apparatus in accordance with certain embodiments of the invention.

FIG. 6 illustrates an apparatus in accordance with certain embodiments of the invention.

FIG. 7 illustrates an apparatus in accordance with certain embodiments of the invention.

FIG. 8 illustrates an apparatus in accordance with certain embodiments of the invention.

FIG. 9 illustrates a system in accordance with certain embodiments of the invention.

### DETAILED DESCRIPTION:

Certain embodiments of the present invention relate to data activity handling in a secondary cell according to its channel quality towards a served user equipment (UE). Certain embodiments of the present invention are directed to a method for handling in one cell, named “primary cell,” the channel quality of another cell, named “secondary cell,” as perceived by a UE that is served by both cells. In certain embodiments of the present invention, the primary cell and the secondary cell belong to the LTE radio technology. In one embodiment of the present invention, the primary cell and the secondary cell belong to different radio technologies, as for example LTE and WLAN, respectively. The method of certain embodiments optimizes a data throughput offered to a served User Equipment (UE). In LTE, a Secondary Cell (SCell) is a cell that has been configured (at the UE) in addition to a Primary Cell (PCell), with which the UE has established a radio connection. The SCell provides additional radio resources for data transmission (as described within Technical Specification 36.331 [1], for example). A UE that is configured with both the PCell and one or more SCells is either in Carrier Aggregation (CA), or in Dual Connectivity (DC), depending on whether the serving cells belong to a same or to different evolved Node Bs (eNBs). DC operation foresees that a multi-transceiver UE is configured to utilize radio resources that are provided by two distinct eNBs (a Master eNB (MeNB) and a Secondary eNB (SeNB)). The multi-transceiver UE and the eNBs (the MeNB and the SeNB) may be connected via a non-ideal backhaul over an X2 interface (as described within 3GPP Technical Report 36.842 [2], for example).

For both CA and DC, the UE may have one Radio Resource Control (RRC) connection with the PCell. In DC, the PCell is located in the MeNB, while inter-eNB control plane signalling for DC is performed by means of X2 interface signalling.

For an efficient usage of the allocated radio resources, data transmission from a configured SCell should be suspended if a channel quality (corresponding to the channel for serving the data transmission to the UE) is detected to be a bad channel quality. The data transmission should be resumed as soon as the channel quality towards the served UE becomes good again. In LTE, the UE can report the detected channel quality from a serving cell via both layer 3 measurements (see TS 36.331 [1] and further details below) and via layer 2 indicators (such as by Channel State Information (CSI) reports, and/or Hybrid Automatic Repeat Request (HARQ) ack/nack, see TS 36.213 [3]).

Layer 3 measurements can be activated at the UE to report the detected channel quality of a configured SCell. Applicable layer 3 measurements can be event A1 (where a serving cell quality is better than a threshold) and event A2 (where a serving cell quality is lower than a threshold; see TS 36.331 [1]). However, to report such measurements, the respective SCell must be detectable/measurable by the UE, which may not always be the case.

Because a layer 3 measurement report needs an RRC procedure, and the layer 3 report is sent by the UE to the PCell (although the report relates to a SCell), the report may not be transmitted as fast as required.

Finally, layer 3 measurements may cover only the downlink channel quality, whereas sometimes only the uplink direction is degraded. In view of the above, layer 2 measurements are the most promising type of measurements for use, as they offer the following advantages. First, layer 2 measurements can be directly handled in the concerned SCell (for example, in the cell which has to take the action). Within the concerned SCell, activation of data transmission, suspension of data transmission, or resumption of data transmission may be handled. Second, layer 2 measurements do not require a RRC procedure/signaling. Third, layer 2 measurements cover both the uplink and the downlink channel directions.

Yet, there are also challenges with regard to using layer 2 measurements. Although the immediate action has to be taken in the SCell, sometimes the PCell also has to do something, depending on the actual channel condition of the SCell.

With the previous approaches, neither the X2-U specifications (see TS 36.425 [6]) nor the X2-C specifications (see TS 36.423 [7]) allow the secondary eNB (SeNB) and the master eNB (MeNB) to exchange channel quality information about the UE configured SCells.

Via the X2-U DL DELIVERY STATUS procedure, the SeNB can control the data flow from the MeNB. The SeNB can inform the MeNB about the minimum and the desired buffer size that the SeNB would like to receive for the UE and for the concerned enhanced Radio Access Bearer (e-RAB), respectively. However, the SeNB does not provide any indication why a given buffer size is required.

For example, a “0” desired buffer size indication can be due to SCell overload or due to bad channel quality. Via the X2-C SENB MODIFICATION REQUIRED procedure, the SeNB can, for example, provide information about reconfiguration of dedicated radio resources or can request an SCell release. However, the SeNB cannot trigger a specific layer 3 measurement.

In the framework of Release 13, 3GPP has approved a new Study Item (SI) for potential enhancements in DC (see RAN#66 document RP-142257 [4]). Within the scope of this SI, a contribution has been submitted (RAN3#87 document R3-150100 [5]). The contribution proposes to enhance the flow control over the X2-U interface (see TS 36.425 [6]) between the MeNB and the SeNB. The flow control can be enhanced by periodically exchanging a UE throughput history information for split bearers.

This type of information/information field, which indicates an average UE throughput history at the SeNB or the MeNB, can be periodically provided to the SeNB or to the MeNB. Once provided, the SeNB or the MeNB can use the information field to decide how to allocate the SeNB's or the MeNB's own resources to the UE.

The proposal of the contribution adds the UE throughput history information in the exchanged DL USER DATA and DL DATA DELIVERY STATUS at the X2-U interface only when there is data to be transmitted in the corresponding UE buffer. Otherwise, the UE throughput history information can be omitted.

Although beneficial for UE throughput, the proposal of the contribution does not convey specific channel quality indications from the SCell/SeNB to the PCell/MeNB. Such specific channel quality indications are required by the PCell/MeNB to take the appropriate actions.

PCT/EP2013/066676 is also directed to efficient communication between an SeNB and an MeNB, when the data handling by the SeNB is suddenly de-configured while the MeNB operation remains. PCT/EP2013/066676 is applicable to UE mobility between SeNBs under a given MeNB and is also applicable to bad channel quality conditions of the SeNB UE serving cells.

An X2 report with new information is proposed by PCT/EP2013/066676, by which the SeNB communicates to the MeNB about non-transmitted Radio Link Control (RLC) data.

As a triggering criterion, such a report can be transmitted as a response to a direct SeNB/SCell de-configuration/de-activation message that is transmitted over X2 by the MeNB.

As an indication, such a report can be transmitted by the SeNB to the MeNB to indicate that that the SeNB is not able to deliver U-plane data to the UE (for example, the SeNB may not be able to deliver the data due to radio link failure). The MeNB can interpret this report as an SeNB/SCell de-configuration/de-activation request. In this case, as also in accordance with certain embodiments of the present invention, an indication may be needed for the MeNB to differentiate an SeNB/Scell de-configuration/de-activation request from a possible received regular RLC Status PDU, which can be conveyed via an additional “cause” field that has not been specified well.

When used as an indication, the “cause” field can convey the SCell channel quality information. However, the content of this “cause” with reference to the SCell channel status condition is not detailed, as the aim of the previous approaches is not to trigger the MeNB to start or stop appropriate UE measurements. Rather, the aim of the previous approaches is to resume RLC PDU retransmission or transmission from the MeNB as soon as possible.

Besides, even if the “cause” would be properly defined and the indication sent at the appropriate point in time, for example, when one of the SeNB SCell experiences bad channel quality, there are cases when the RLC PDUs can still be transmitted from another SCell in the SeNB with good channel quality. In other words, the RLC PDU status and the SeNB SCell channel status conditions can be uncorrelated/unrelated.

Finally, according to certain embodiments of the present invention, it may be important to signal when the channel quality becomes good again, to stop running UE measurements.

With certain embodiments of the present invention, the SCell/SeNB communicates to the PCell/MeNB about the SCell channel quality condition when the quality condition become so critical as to require an action of the PCell/MeNB. Based on the SCell quality communication, the PCell/MeNB takes action/counter measures, which can be implementation specific, as described in more detail below.

Certain embodiments of the present invention may enhance the X2-U protocol so that the SCell/SeNB can convey the following information to the PCell/MeNB. The SCell/SeNB can convey that the channel quality of the SCell has become bad. The SCell/SeNB can convey that the channel quality of the SCell has become good. The SCell/SeNB can convey that the SCell is no longer detectable by the UE, as described in more detail below.

Certain embodiments of the invention may enhance the X2-C protocol so that the SCell/SeNB can convey the following information to the PCell/MeNB. The SCell/SeNB can convey information relating to activation of a measurement configuration at the UE. The SCell/SeNB can convey information relating to deactivation of a measurement configuration at the UE. The SCell/SeNB can convey information indicating that the SCell is no longer detectable by the UE.

In another embodiment of this invention, the SCell/SeNB can send a “channel quality” indication to the PCell/MeNB for triggering appropriate measurement activation at the UE, even for reasons unrelated to the actual SCell channel quality condition. For example, if the SCell is congested and needs to offload the UE traffic, this indication would trigger the search for alternative SCells that can better serve the UE.

In other embodiments of the present invention, any combination of the above two embodiments can be utilized. To reduce the exchanged signaling, the SCell/SeNB may inform the PCell/MeNB only when there is a change in the SCell channel status condition.

Although the SCell/SeNB first has to react against the SCell channel condition, for example, by suspending or resuming the data transmission, there may be other required actions that only the Pcell/MeNB can take, due to the architectural split, as described below. If the SCell channel quality is bad, the PCell may activate Inter-frequency A3 or A5 measurements at the UE for finding a better SCell or better SeNB. If the SCell become undetectable, the PCell could activate, at the UE, inter-frequency A4 measurements for finding another SCell. The PCell may possibly release the undetected SCell if no suitable measurement report is received after a pre-defined time. If the SCell channel quality becomes good, the PCell could deactivate, at the UE layer, 3 measurements which may have been activated for finding a better SCell. If the SCell channel quality becomes bad, the PCell can deactivate the SCell by Medium Access Control (MAC) signaling.

To allow the PCell/MeNB to take the appropriate action, with certain embodiments, the SCell/SeNB conveys the SCell Channel quality information to the PCell/MeNB over the X2 interface. The exact unit of SCell channel quality can be: wideband/narrowband modulation and coding scheme (MCS), and/or wideband/narrowband corrected channel state information (CSI), and/or wideband/narrowband signal-to-interference-plus-noise-ratio (SINR), and/or any other quantity related to SCell's Physical-downlink-control-channel/Physical-downlink-shared-channel (PDCCH/PDSCH) link adaptation. For accuracy reasons, the SCell channel quality may take into account not only the SCell's CSI reported by the UE, but also the SCell's PDCCH/PDSCH transmission. Therefore, such a defined SCell channel quality is initially available only at the SCell and may need to be conveyed to the PCell.

A3 and A5 measurements can generally run only if the current SCell is detectable, whereas A4 measurements are not dependent upon the current SCell being detectable.

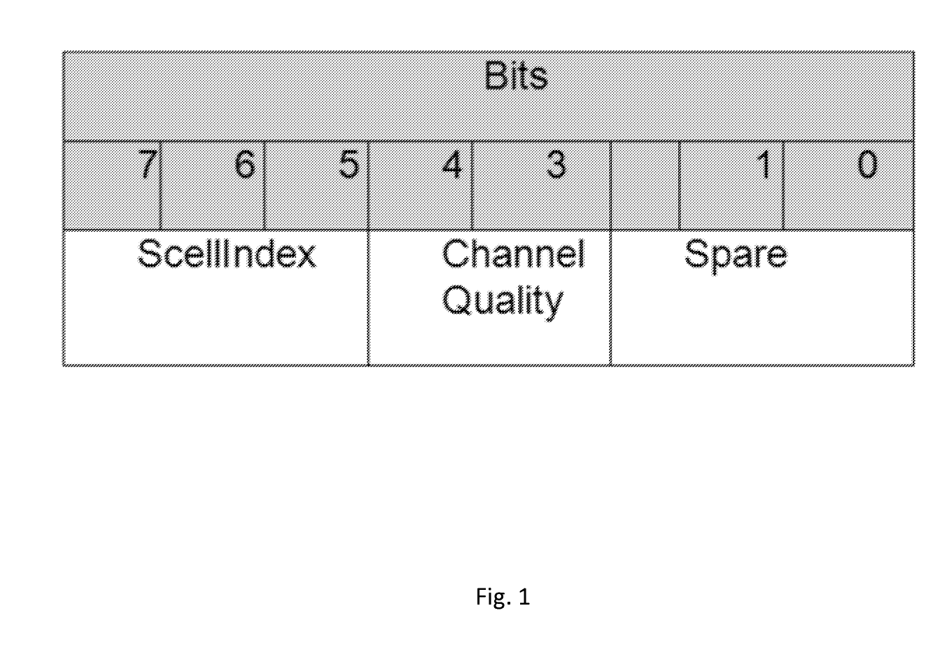

With respect to implementation/realization aspects, certain embodiments may be based on enhanced X2-U protocol. The DL DATA DELIVERY STATUS PDU can be applied, enhanced with the new information “Status of the Connection.” “Status of the Connection” can be one byte field as follows, where SCellIndex identifies the affected SCell, and Channel Quality indicates one of the following values: {good, bad, undetected}. FIG. 1 illustrates a “status of the connection” byte in accordance with certain embodiments of the invention.

Alternatively, a dedicated protocol data unit (PDU), which may be referred to as “DL CHANNEL STATUS,” can be defined for conveying the above described SCell channel quality information over the X2-U interface.

With regard to certain embodiments that are based on the enhanced X2-C protocol, the MeNB to SeNB “X2: SENB MODIFICATION REQUEST” message and the SeNB to MeNB “X2: SENB MODIFICATION REQUIRED” message can be utilized. The messages can be enhanced with the addition of a measConfig field in the SCG-Configuration message of the “MeNB to SeNB -” and “SeNB to MeNB-Container,” respectively, as follows. MeNB includes, in the measConfig field of the X2: SENB MODIFICATION REQUEST message, the configurations (reportConfig) and the identities (measlD) of the measurements which are relevant for the cells of the SeNB. SeNB requests the MeNB to activate one ofthese measurements including, in the measConfig field of the X2: SENB MODIFICATION REQUIRED message, the respective measlD, based on the current SCell channel status condition.

SCell channel quality monitoring can be fast tracked in the relevant SCell/SeNB, without involvement of slow layer 3 measurements. Yet, the SCell/SeNB can fast trigger the PCell/MeNB to take appropriate actions, as required by the current radio channel condition of the respective SCell.

In particular, the PCell/MeNB can activate or deactivate, at the UE layer 3, measurements which better fit to the current SCell channel quality and/or release the SCell.

With regard to the embodiment that primary cell and secondary cell belong to different radio technologies, the secondary cell, e.g. a WiFi Access Point (see TR37.834), can locally estimate the channel conditions towards the served UE from the success rate of data delivery and the achieved data throughput and send corresponding channel quality indication to the UE primary cell, e.g. a LTE cell, over the respective line interface, e.g. Xw (Xw-U or Xw-C). Based on this indication, the primary cell can release the secondary cell or instruct the UE to search for another secondary cell.

Certain embodiments of the present invention may be applicable to one SCell per UE and as to multiple SCells per UE.

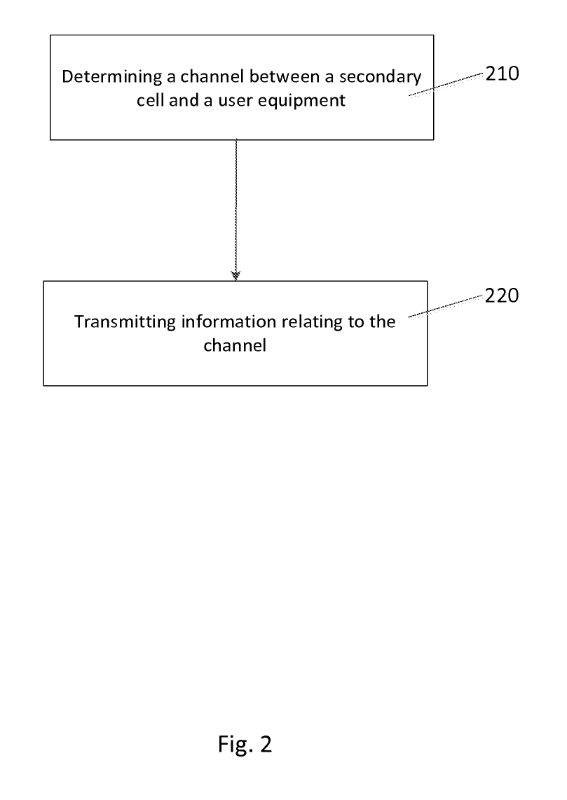

FIG. 2 illustrates a flowchart of a method in accordance with certain embodiments of the invention. The method illustrated in FIG. 2 includes, at 210, determining, by a first network node, a channel between a secondary cell and a user equipment. The method may also include, at 220, transmitting information relating to the channel to a primary cell of a second network node. The transmitting the information comprises transmitting via an interface between the secondary cell and the primary cell.

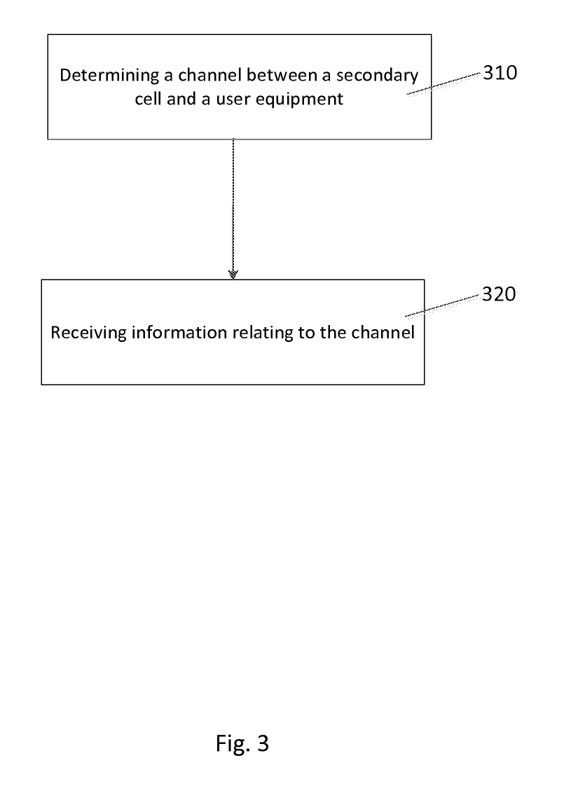

FIG. 3 illustrates a flowchart of a method in accordance with certain embodiments of the invention. The method illustrated in FIG. 3 includes, at 310, determining, by a first network node, a channel between a secondary cell and a user equipment. The method may also include, at 320, receiving information relating to the channel from a second network node.

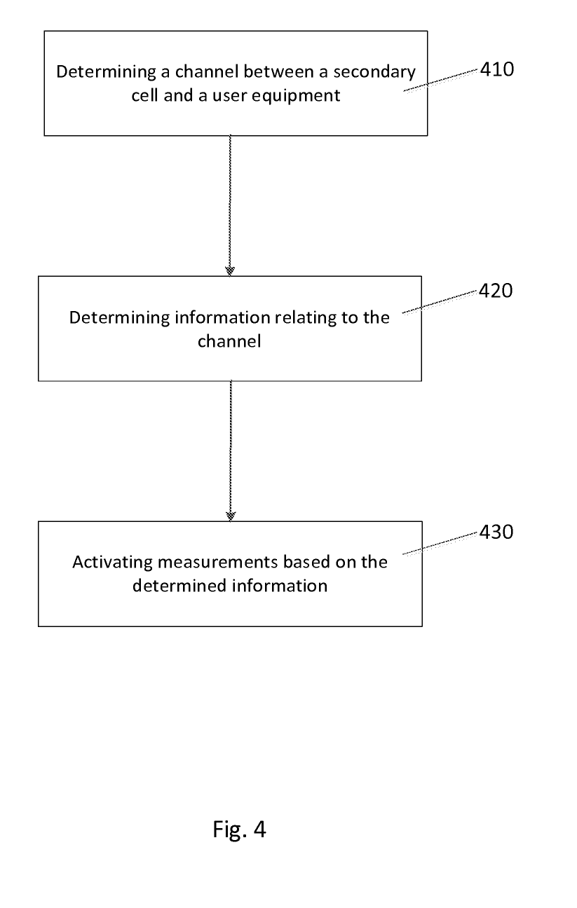

FIG. 4 illustrates a flowchart of a method in accordance with certain embodiments of the invention. The method illustrated in FIG. 4 includes, at 410, determining, by a network node, a channel between a secondary cell and a user equipment. The method also includes, at 420, determining information relating to the channel. The information comprises at least one of information that a channel quality of the channel has become bad, information that a channel quality of the channel has become good, and information that the secondary cell is no longer detectable by the user equipment. The method may also include, at 430, activating measurements based on the determined information.

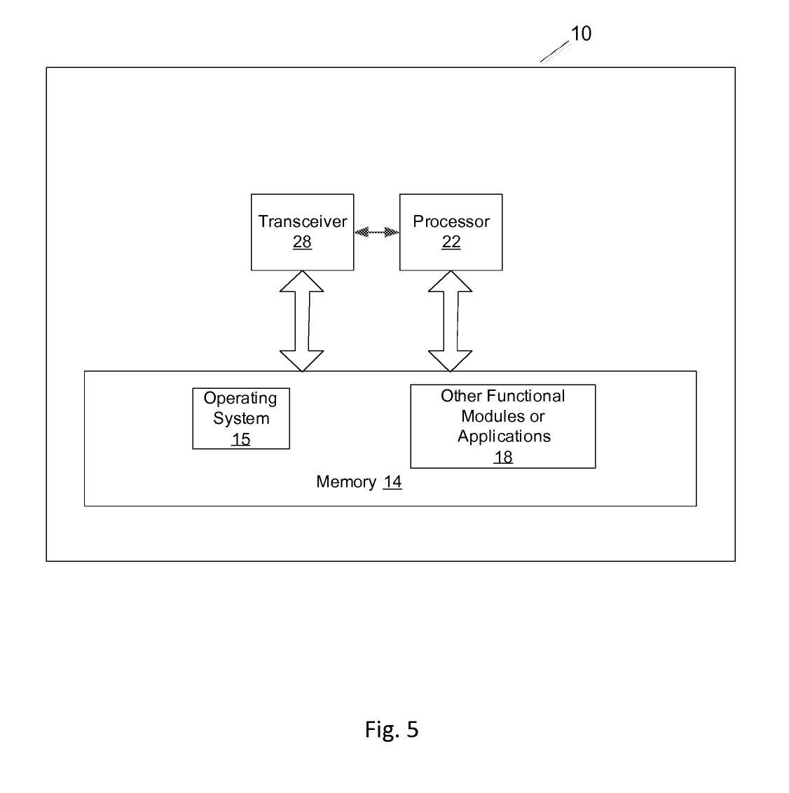

FIG. 5 illustrates an apparatus in accordance with certain embodiments of the invention. In one embodiment, the apparatus can be a user equipment, a base station, and/or an evolved Node B, for example. The apparatus can be a network node. Apparatus 10 can include a processor 22 for processing information and executing instructions or operations. Processor 22 can be any type of general or specific purpose processor. While a single processor 22 is shown in FIG. 5, multiple processors can be utilized according to other embodiments. Processor 22 can also include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples.

Apparatus 10 can further include a memory 14, coupled to processor 22, for storing information and instructions that can be executed by processor 22. Memory 14 can be one or more memories and of any type suitable to the local application environment, and can be implemented using any suitable volatile or nonvolatile data storage technology such as a semiconductor-based memory device, a magnetic memory device and system, an optical memory device and system, fixed memory, and removable memory. For example, memory 14 include any combination of random access memory (RAM), read only memory (ROM), static storage such as a magnetic or optical disk, or any other type of non-transitory machine or computer readable media. The instructions stored in memory 14 can include program instructions or computer program code that, when executed by processor 22, enable the apparatus 10 to perform tasks as described herein.

Apparatus 10 can also include one or more antennas (not shown) for transmitting and receiving signals and/or data to and from apparatus 10. Apparatus 10 can further include a transceiver 28 that modulates information on to a carrier waveform for transmission by the antenna(s) and demodulates information received via the antenna(s) for further processing by other elements of apparatus 10. In other embodiments, transceiver 28 can be capable of transmitting and receiving signals or data directly.

Processor 22 can perform functions associated with the operation of apparatus 10 including, without limitation, precoding of antenna gain/phase parameters, encoding and decoding of individual bits forming a communication message, formatting of information, and overall control of the apparatus 10, including processes related to management of communication resources. For example, apparatus 10 may perform the method illustrated by FIGS. 2-4.

In an embodiment, memory 14 can store software modules that provide functionality when executed by processor 22. The modules can include an operating system 15 that provides operating system functionality for apparatus 10. The memory can also store one or more functional modules 18, such as an application or program, to provide additional functionality for apparatus 10. The components of apparatus 10 can be implemented in hardware, or as any suitable combination of hardware and software.

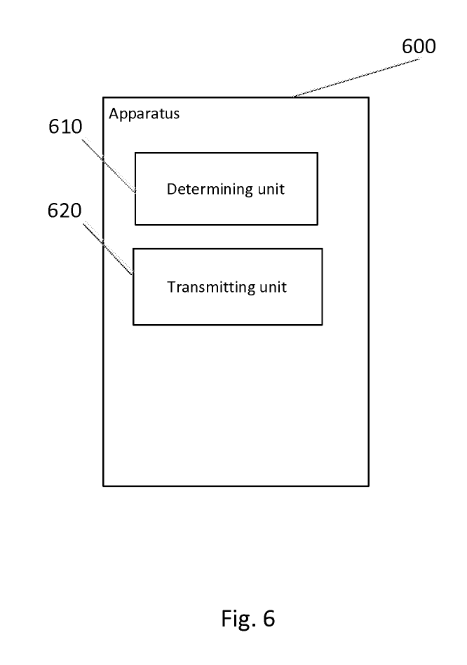

FIG. 6 illustrates an apparatus in accordance with certain embodiments of the invention. Apparatus 600 can be a network element/entity such as a secondary eNB, for example. Apparatus 600 can include a determining unit 610 that determines a channel between a secondary cell and a user equipment. Apparatus 600 can also include a transmitting unit 620 that transmits information relating to the channel to a primary cell of a network node. The transmitting the information comprises transmitting via an interface between the secondary cell and the primary cell.

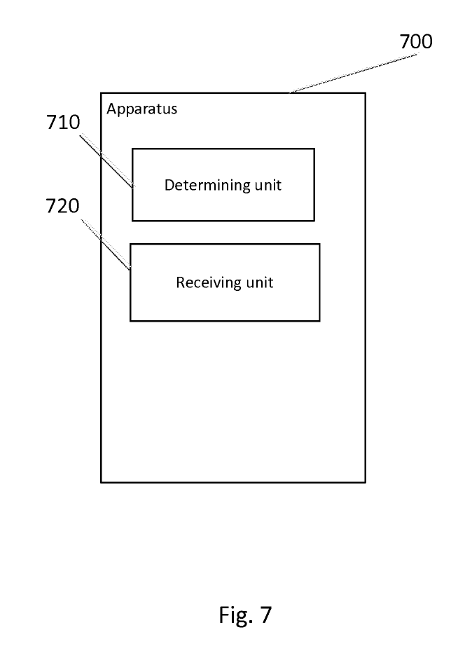

FIG. 7 illustrates an apparatus in accordance with certain embodiments of the invention. Apparatus 700 can be a network element/entity such as a master eNB, for example. Apparatus 700 can include a determining unit 710 that determines a channel between a secondary cell and a user equipment. Apparatus 700 can also include a receiving unit 720 that receives information relating to the channel from a network node.

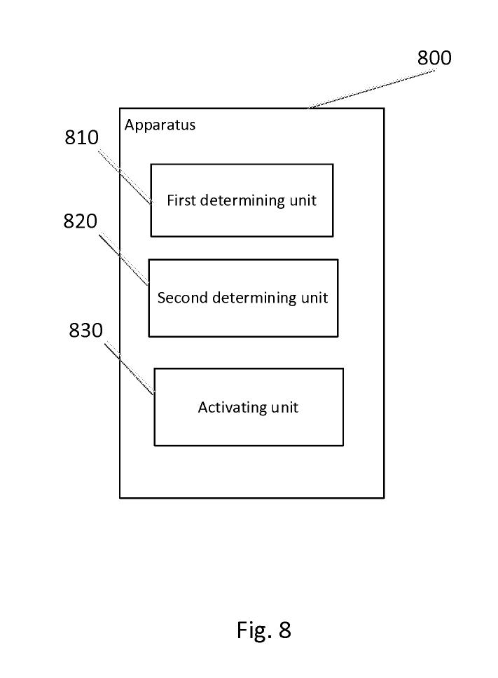

FIG. 8 illustrates an apparatus in accordance with certain embodiments of the invention. Apparatus 800 can be a network element/entity such as an eNB, for example. Apparatus 800 can include a first determining unit 810 that determines a channel between a secondary cell and a user equipment. Apparatus 800 may also include a second determining unit 820 that determines information relating to the channel. The information comprises at least one of information that a channel quality of the channel has become bad, information that a channel quality of the channel has become good, and information that the secondary cell is no longer detectable by the user equipment. Apparatus 800 may also include an activating unit 830 that activates measurements based on the determined information.

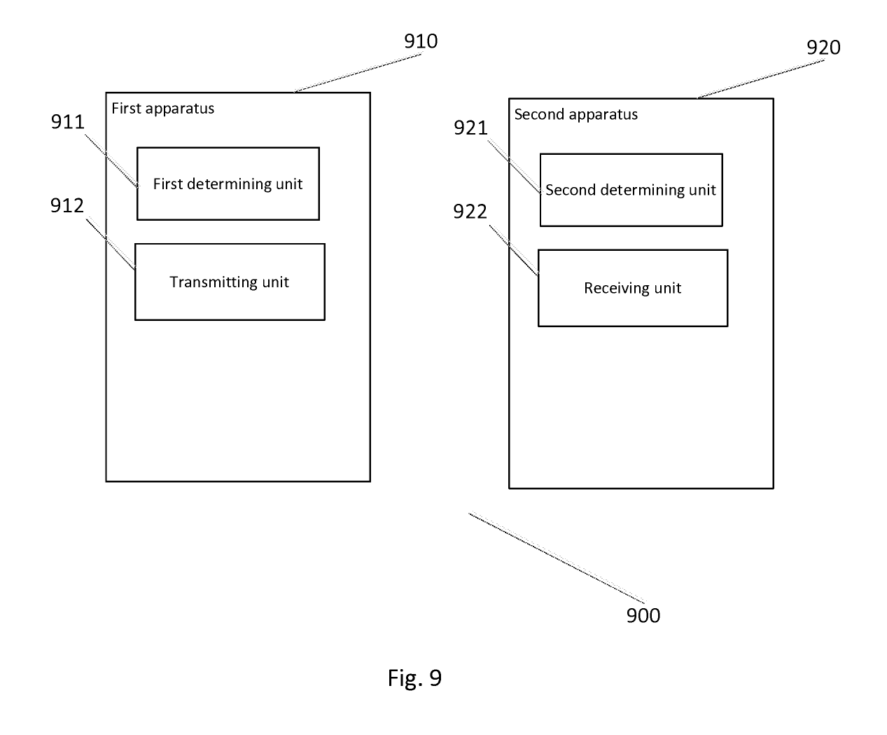

FIG. 9 illustrates a system in accordance with certain embodiments of the invention. First apparatus 910 can be a network element/entity such as a secondary eNB, for example. First apparatus 910 can include a first determining unit 911 that determines a channel between a secondary cell and a user equipment. First apparatus 910 can also include a transmitting unit 912 that transmits information relating to the channel to a primary cell of a second apparatus 920. The transmitting the information comprises transmitting via an interface between the secondary cell and the primary cell. Second apparatus 920 can include a second determining unit 921 that determines the channel. Second apparatus 920 can also include a receiving unit 922 that receives the information relating to the channel from the first apparatus 910.

The described features, advantages, and characteristics of the invention can be combined in any suitable manner in one or more embodiments. One skilled in the relevant art will recognize that the invention can be practiced without one or more of the specific features or advantages of a particular embodiment. In other instances, additional features and advantages can be recognized in certain embodiments that may not be present in all embodiments of the invention. One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

1. A method, comprising:
determining, by a first network node, a channel between a secondary cell and a user equipment; and
transmitting information relating to the channel to a primary cell of a second network node, wherein the transmitting the information comprises transmitting via an interface between the secondary cell and the primary cell.

2. The method according to claim 1, wherein the first network node comprises a secondary evolved Node B, the second network node comprises a master evolved Node B, and the information exchanged between the secondary cell and the primary cell is exchanged via an external X2 interface between the secondary evolved Node B and the master evolved Node B.

3. The method according to claim 1, wherein the first network node and the second network node correspond to the same evolved Node B, and the information exchanged between the secondary cell and the primary cell is exchanged via an internal X2 interface within the evolved Node B.

4. The method according to claim 1, wherein the first network node and the second network node belong to different radio technologies and the information exchanged between the secondary cell and the primary cell is exchanged via an external interface defined between the secondary network node and the primary network node.

5. The method according to claim 1, wherein the first network node is a WLAN, the second network node is an evolved Node B, and the information exchanged between the secondary cell and the primary cell is exchanged via an external Xw interface defined between the WLAN and the evolved Node B.

6. The method according to claim 3 or 1, wherein the transmitting information relating to the channel comprises transmitting via the X2-U protocol, and the transmitting information comprises transmitting at least one of information that a channel quality of the channel has become bad, information that a channel quality of the channel has become good, and information that the secondary cell is no longer detectable by the user equipment.

7.-9. (canceled)

10. An apparatus, comprising:
at least one processor; and
at least one memory including computer program code,
the at least one memory and the computer program code configured, with the at least one processor, to cause the apparatus at least to
determine a channel between a secondary cell and a user equipment; and
transmit information relating to the channel to a primary cell of a network node, wherein the transmitting the information comprises transmitting via an interface between the secondary cell and the primary cell.

11. The apparatus according to claim 10, wherein the apparatus comprises a secondary evolved Node B, the network node comprises a master evolved Node B, and the information exchanged between the secondary cell and the primary cell is exchanged via an external X2 interface between the secondary evolved Node B and the master evolved Node B.

12. The apparatus according to claim 10, wherein the apparatus and the network node correspond to the same evolved Node B, and the information exchanged between the secondary cell and the primary cell is exchanged via an internal X2 interface within the evolved Node B.

13. The apparatus according to claim 10, wherein the apparatus and the network node belong to different radio technologies and the information exchanged between the secondary cell and the primary cell is exchanged via an external interface defined between the secondary network node and the primary network node.

14. The apparatus according to claim 10, wherein the apparatus is a WLAN, the network node is an evolved Node B, and the information exchanged between the secondary cell and the primary cell is exchanged via an external Xw interface defined between the WLAN and the evolved Node B.

15. The apparatus according to claim 12, wherein the transmitting information relating to the channel comprises transmitting via the X2-U protocol, and the transmitting information comprises transmitting at least one of information that a channel quality of the channel has become bad, information that a channel quality of the channel has become good, and information that the secondary cell is no longer detectable by the user equipment.

16. (canceled)

17. The apparatus according to claim 12, wherein the transmitting the information relating to the channel comprises transmitting via the X2-C protocol, the transmitting information comprises transmitting at least one of information relating to activation of a measurement configuration at the user equipment, information relating to deactivation of a measurement configuration at the user equipment, and information indicating that the secondary cell is no longer detectable by the user equipment.

18. (canceled)

19. A computer program product, embodied on a non-transitory computer readable medium, the computer program product configured to control a processor to perform a method according to claim 1.

20. A method, comprising:
determining, by a first network node, a channel between a secondary cell and a user equipment; and
receiving information relating to the channel from a second network node.

21. The method according to claim 20, wherein the second network node comprises a secondary evolved Node B, and the first network node comprises a master evolved Node B.

22.-28. (canceled)

29. An apparatus, comprising:
at least one processor; and
at least one memory including computer program code,
the at least one memory and the computer program code configured, with the at least one processor, to cause the apparatus at least to
determine a channel between a secondary cell and a user equipment; and
receive information relating to the channel from a network node.

30. The apparatus according to claim 29, wherein the network node comprises a secondary evolved Node B, and the apparatus comprises a master evolved Node B.

31. The apparatus according to claim 30, wherein the secondary evolved Node B and the master evolved Node B are the same evolved NodeB.

32. The apparatus according to claim 29, wherein the network node comprises a master evolved Node B and the apparatus comprises a node of different radio technology

33.-41. (canceled)
